(19) United States
(12) Patent Application Publication
(10) Pub. No.: US 2012/0224191 A1
(43) Pub. Date: Sep. 6, 2012

(54) Image Forming Apparatus

(75) Inventor: Yasuhiro Abe, Kanagawa (JP)

(73) Assignee: RICOH COMPANY, LTD., Tokyo (JP)

(21) Appl. No.: 13/361,440

(22) Filed: Jan. 30, 2012

(30) Foreign Application Priority Data
Mar. 1, 2011 (JP) 2011-043646

(51) Int. Cl. G06F 15/00

(52) U.S. Cl. 358/1.5

(57) ABSTRACT

An image forming apparatus, including an image forming unit to form a full-color image on an intermediate transfer member; a pattern image forming unit to form a pattern image on the intermediate transfer member for correcting image forming conditions; a pattern image detecting unit to detect the pattern image; a correcting unit to correct the image forming conditions; a positional shift amount calculating unit to calculate a positional shift amount; a positional shift amount storage unit to store the positional shift amount calculated by the positional shift amount calculating unit; and a pattern image correcting unit to correct a position of the pattern image in a main scanning direction and a width thereof to be smaller than an initial width in the main scanning direction, when the pattern image forming unit forms a pattern image on the intermediate transfer member.

### CROSS-REFERENCE TO RELATED APPLICATION

This patent application is based on and claims priority pursuant to 35 U.S.C. §119 to Japanese Patent Application No. 2011-043646, filed on Mar. 1, 2011, in the Japanese Patent Office, the entire disclosure of which is hereby incorporated by reference herein.

### BACKGROUND OF THE INVENTION

1. Field of the Invention

The present invention relates to an image forming apparatus such as facsimiles, printers, copiers and their complex machines.

2. Description of the Related Art

In image forming apparatuses such as facsimiles, printers, copiers, and multi-function machines combining several of these capabilities, an image adjustment process involving such procedures as color shift correction and image density correction is performed using a test pattern (for image adjustment) formed with toner on an intermediate transfer belt and detecting the test pattern with a sensor.

Typically, to ensure good image adjustment precision the test pattern has a width in a main scanning direction large enough for the sensor to detect the test pattern even when the position of the sensor or of an optical scanning system shifts due to temperature variation.

However, forming the test pattern with such a large main scanning width relative to the detection area of the sensor wastes toner because much of the pattern simply goes undetected.

Ultimately, the image adjustment process in an image forming apparatus has three competing objectives; i.e., (1) toner consumption reduction, (2) image adjustment preciseness, and (3) apparatus downtime reduction. There is a trade-off between these objectives, and while it has been possible to achieve any one of them it has so far not been possible to achieve all three at the same time.

Therefore, a long-felt need exists for an image forming apparatus capable of performing image adjustment with the same consistent precision while reducing toner consumption and apparatus downtime.

### BRIEF SUMMARY OF THE INVENTION

Accordingly, an object of the present invention is to provide an image forming apparatus, method, and means capable of performing image adjustment process with the same consistent precision while reducing toner consumption and downtime.

These objects and other objects of the present invention, either individually or collectively, have been satisfied by the discovery of an image forming apparatus, comprising:

an image forming unit configured to overlappingly transfer a different color toner image formed on each of plural image bearers onto an intermediate transfer member to form a full-color image thereon;

a pattern image forming unit configured to form a pattern image on the intermediate transfer member for correcting image forming conditions when the image forming unit forms the full-color image on the intermediate transfer member;

a pattern image detecting unit configured to detect the pattern image; and

a correcting unit configured to correct the image forming conditions when the image forming unit forms the full-color image on the intermediate transfer member, based on a detected result of the pattern image detecting unit,

wherein the image forming apparatus further comprises:

a positional shift amount calculating unit configured to calculate a positional shift amount when the pattern image forming unit fauns a pattern image on the intermediate transfer member, based on a detected result of the pattern image detecting unit;

a positional shift amount storage unit configured to store the positional shift amount calculated by the positional shift amount calculating unit; and

a pattern image correcting unit configured to correct a position of the pattern image in a main scanning direction and a width thereof to be smaller than an initial width in the main scanning direction, based on the positional shift amount stored by the positional shift amount storage unit, when the pattern image forming unit forms a pattern image on the intermediate transfer member.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a block diagram illustrating an embodiment of the image forming apparatus of the present invention;

FIG. 2 is a schematic view illustrating an inner configuration of each detection sensor in FIG. 1;

FIG. 3 is a block diagram showing the inner configuration of the detection sensor of the image forming apparatus in FIG. 1, and a functional configuration governing processing of data detected by a detection sensor in a controller thereof;

FIG. 4 is a diagram showing a set of marks in a pattern image for correcting positional shift, and a waveform example of a detected result of the set of marks;

FIG. 5 is a diagram showing a set of marks in the pattern image for correcting positional shift for explaining calculation of a shift amount based on the detected results of the pattern image for correcting positional shift in FIG. 4;

FIG. 6 is a diagram showing a pattern image example for explaining a pattern image correction process of a test pattern image for correcting positional shift;

FIG. 7 is a diagram showing another pattern image example for explaining a pattern image correction process of a test pattern image for correcting positional shift;

FIG. 8 is a diagram showing a pattern image example for explaining a pattern image correction process of a test pattern image for correcting image density;

FIG. 9 is a diagram showing another pattern image example for explaining a pattern image correction process of a test pattern image for correcting image density;

FIG. 10 is a flowchart showing the pattern image correction process by a CPU in FIG. 3;

FIG. 11 is a diagram showing a test pattern image for correcting positional shift example formed when plural detection sensors are located at different positions in a main scanning direction of an intermediate transfer belt; and

FIG. 12 is a schematic view for explaining a pattern width of a test pattern image for adjusting images as time passes.

### DETAILED DESCRIPTION OF THE INVENTION

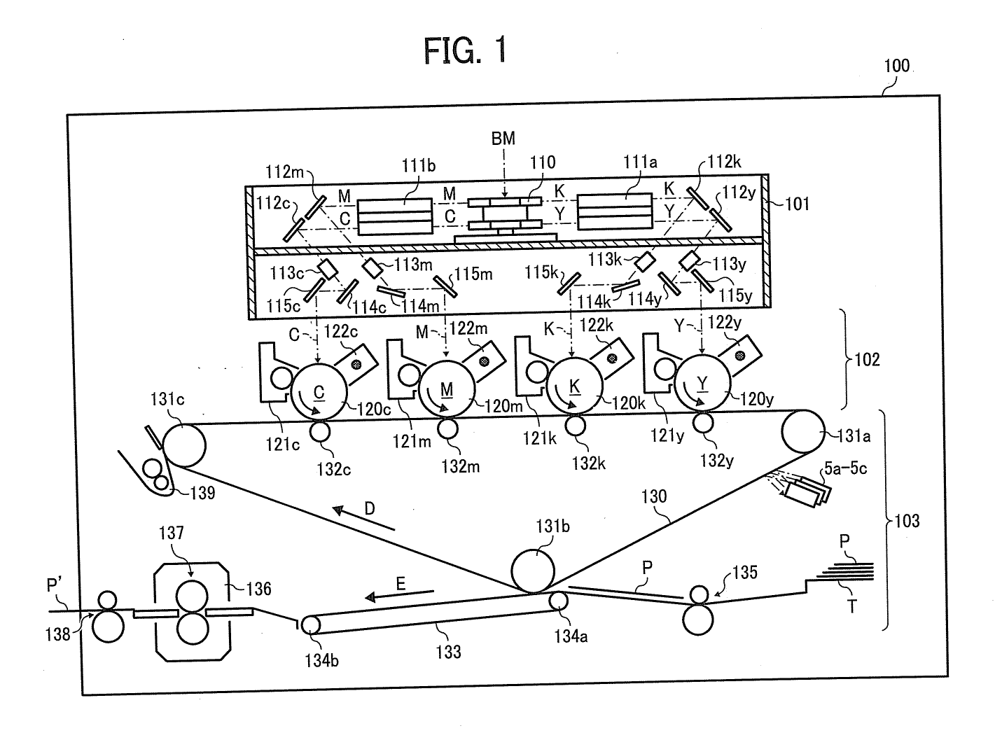

FIG. 1 is a block diagram illustrating an embodiment of the image forming apparatus of the present invention. An image forming apparatus 100 is an image processor such as facsimiles, printers, copiers and their complex machines, and includes an optical unit 101 including optical elements such as LD light sources and polygon mirrors; an image forming unit 102 including a photoreceptor such as a drum-shaped photoreceptor (photoreceptor drum), a charger, an image developer; and a transfer unit 103 including an intermediate transfer belt. Namely, the optical unit 101, the image forming unit 102 and the transfer unit 103 serve as image forming means and pattern image forming means.

The optical unit 101 deflects laser beams BM emitted from unillustrated plural LD light sources with a polygon mirror 110 and injects them into scanning lenses 111a and 111b including an fθ lens. The laser beams corresponding to each yellow (Y), black (K), magenta (M) and cyan (C) color image are emitted, and after passing the scanning lenses 111a and 111b, they are reflected by reflections mirrors 112y, 112k, 112m and 112c.

For example, a yellow laser beam Y transmits the scanning lens 111a, and is reflected by the reflection mirror 112y and injected to a WT lens 113y. Each black (K), magenta (M) and cyan (C) color laser beam is the same and explanations thereof are omitted.

WTL lenses 113y to 113c, after reforming each laser beam Y to C, deflect them to reflection mirrors 114y to 114c, and they are further reflected by reflection mirrors 115y to 115C and imagewisely irradiated to photoreceptor drums (photoreceptors) 120y to 120c.

As mentioned above, plural optical elements are used in irradiating the laser beams Y to C to the photoreceptors 120y to 120c, and they are synchronized in timing in a main scanning direction and a sub-scanning direction relative to the photoreceptors 120y to 120c.

The main scanning direction relative to the photoreceptors 120y to 120c is a scanning direction of the laser beam and the sub-scanning direction is a direction perpendicular to the main scanning direction, i.e., a rotational direction of the photoreceptors 120y to 120c.

Each of the photoreceptors 120y to 120c includes a photoconductive layer including at least a charge generation layer and a charge transport layer on an electroconductive drum such as aluminum.

Each of the surface of the photoconductive layers is charged by each of chargers 122y to 122c such as corotrons, scorotrons and charging rollers.

Each of the photoreceptors 120y to 120c charged by each of the chargers 122y to 122c is imagewisely irradiated with the laser beams Y to C to form an electrostatic latent image on the scanned surface of each of the photoreceptors 120y to 120c.

The electrostatic latent image formed on the scanned surface of each of the photoreceptors 120y to 120c is developed by each of image developers 121y to 121c including a developing sleeve, a developer feed roller, a regulation blade, etc. to form a developer image on the scanned surface of each of the photoreceptors 120y to 120c.

The developer image borne on the scanned surface of each of the photoreceptors 120y to 120c is transferred by each of feed rollers 131a to 131c onto an intermediate transfer belt 130 traveling in an arrow D direction. Each of 132y to 132c is a first transfer roller for each of the photoreceptors 120y to 120c.

The intermediate transfer belt 130 is fed to a second transferer while bearing Y, K, M and C developers transferred from the scanned surface of each of the photoreceptors 120y to 120c. Namely, the intermediate transfer belt 130 is an intermediate transfer member.

The second transfer includes a second transfer belt 133, and feed rollers 134a and 134b.

The second transfer belt 133 is fed by the feed rollers 134a and 134b in an arrow E direction.

To the second transferer, a paper P as an image receiving material such as plain papers and plastic sheets is fed by a feed roller 135 from a paper container T such as paper cassettes.

The second transferer transfers the multicolor developer image borne on the intermediate transfer belt 130 to the paper P adsorbed on the second transfer belt 133 with application of a second transfer bias.

The paper P is fed to a fixer 136 with travel of the second transfer belt 133.

The fixer 136 includes a fixing member 137 such as fixing rollers including silicone rubbers, fluorine-containing rubbers, etc. and pressurizes and heats the paper P and the multicolor developer image to discharge the paper P as a printed material P′ out of the image forming apparatus 100 with a paper discharge roller 138.

After the multicolor developer image is transferred, an untransferred developer is removed from the intermediate transfer belt 130 by a cleaner 139 including a cleaning blade, and the intermediate transfer belt 130 is prepared for the following image forming process.

Near the feed roller 131a, three detection sensors 5a to 5c detecting a pattern image (including “a test pattern image for correcting color shift” and “a test pattern image for correcting image density”) for correcting image forming conditions when forming a full-color image on the intermediate transfer belt 130.

Each of the detection sensors 5a to 5c may be a reflection detection sensor including a known reflection photosensor. Based on detection results of each of the detection sensors 5a to 5c, various shift amounts such as a skew (gradient) of each color relative to a standard color, a main scanning registration shift amount, a sub-scanning registration shift amount and a main scanning magnification error are calculated. Based on the calculation results, the various shift amounts relating to image adjustment are corrected, and image forming conditions (positional shift and image density) when forming a full-color image on the intermediate transfer belt 130. In addition, various processes relating to production of the test pattern image when adjusting image are executed.

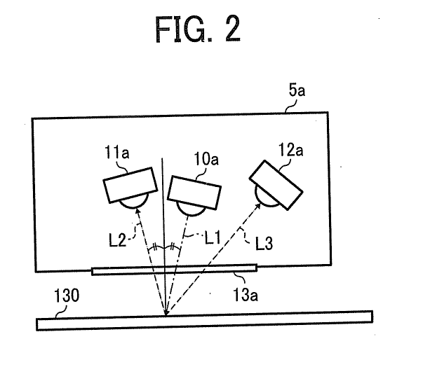

FIG. 2 is a schematic view illustrating an inner configuration of each of the detection sensors 5a to 5c in FIG. 1.

The inner configurations of the detection sensors 5a to 5c are same. FIG. 2 illustrates the inner configuration of the detection sensor 5a, and those o the 5b and 5c are omitted.

The detection sensor 5a includes a light emitter 10a, two light receivers 11a and 12a, and a collecting lens 13a.

The light emitter 10a is a light emitting element, e.g., an infrared LED emitting infrared light.

The light receiver 11a is, e.g., a regular reflection light receiving element, 12a is, e.g., a diffuse reflection light receiving element.

Light L1 emitted from the light emitter 10a reaches a test pattern (unillustrated) on the intermediate transfer belt 130 after passing the collecting lens 13a.

A part of the light L2 regularly reflected at a test pattern forming area and a toner layer thereof passes again the collecting lens 13a, and is received by the light receiver 11a.

In addition, another part of the light L3 diffusely reflected at a test pattern forming area and a toner layer thereof passes again the collecting lens 13a, and is received by the light receiver 12a.

As the light emitting element, a laser emitting element may be used instead of the infrared LED.

As the light receivers 11a and 12a (the regular reflection light receiving element and the diffuse reflection light receiving element), phototransistors are used for both of them, and photodiodes and amplifying circuits may be used.

Next, a function governing processing of data detected by the detection sensors 5a to 5c in the image forming apparatus 100 is explained.

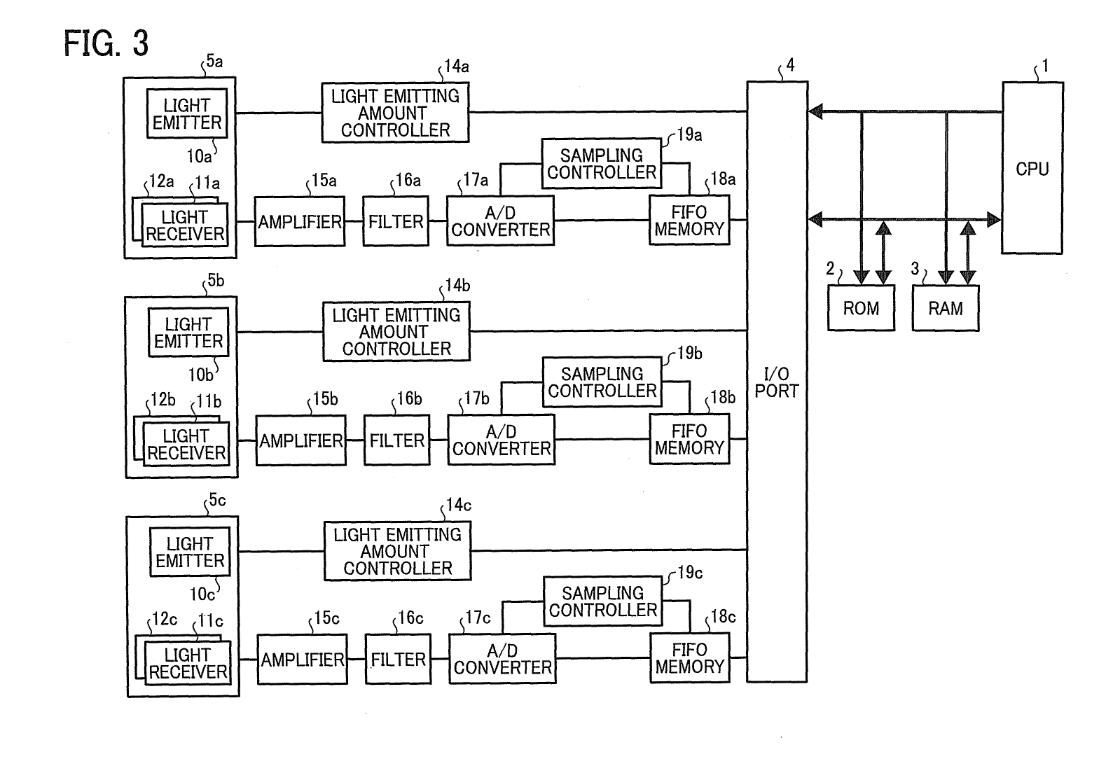

FIG. 3 is a block diagram showing the inner configuration of each of the detection sensors 5a to 5c of the image forming apparatus 100 in FIG. 1, and a functional configuration governing processing of data detected by the detection sensors 5a to 5c in a controller thereof.

The detection sensors 5a to 5c of the image forming apparatus 100 include the light emitters (equivalent to light emitting means) 10a to 10c and the light receivers (equivalent to “pattern image detection means”) 11a to 11c and 12a to 12c, respectively. The illustration of the collecting lenses 13a to 13c illustrated in FIG. 2 is omitted.

The controller of the image forming apparatus 100 includes, as a function of processing data detected by the detection sensors 5a to 5c, CPU1, ROM2, RAM3, I/O (Input/Output) port, light emitting amount controllers 14a to 14c, amplifiers (AMP) 15a to 15c, filters 16a to 16c, A/D (Analog/Digital) converters 17a to 17c, First-In First-Out (FIFO) memories 18a to 18c, and sampling controllers 19a to 19c.

In ROM2, various programs controlling the image forming apparatus 100 such as a correction process correcting image forming conditions when forming a full-color image on the intermediate transfer belt 130, a positional shift amount calculation process calculating a positional shift amount in a main scanning direction when forming a pattern image on the intermediate transfer belt 130, and programs executed by the CPU1 for various processes including a pattern image correction process.

In addition, the CPU1 monitors detection signals from the light receivers 11a to 11c at a proper timing, controls light emitting amount with the light emitting amount controllers 14a to 14c to perform reliable detection even when the transfer belt and the light emitters 10a to 10c deteriorate, and makes a level of a light receiving signal from the light receivers constant.

Next, a processing of data detected by the detection sensors 5a to 5c is explained, referring to FIG. 3.

The CPU1 executes programs stored in the ROM2 while RAM3 is an operation area to control the light emitting amount controllers 14a to 14c through the I/O port 4 such that each of the light emitters 10a to 10c of the detection sensors 5a to 5c irradiates laser beams having a predetermined light amount when detecting a test pattern image mentioned in detail later.

First, a laser beam emitted from the light emitter 10a of the detection sensor 5a is irradiated to a test pattern image and the light receivers 11a and 12a receive its reflected light.

Each of the light receivers 11a and 12a transmits data signal depending on a light amount of the laser beam each of them receives to the amplifier 15a. The data signal is amplified by the amplifier 15a and transmitted to the filter 16a passing only a line detection signal component. The line detection signal component is transmitted to the A/D converter 17a and converted from analog data to digital data.

The sampling controller 19a samples digital data converted by the A/D converter 17a and stores the data sampled in the FIFO memory 18a.

Similarly, data signals from the light receivers 11b and 12b of the detection sensor 5b are digitalized, sampled and stored in the FIFO memory 18b. Data signals from the light receivers 11c and 12c of the detection sensor 5c are digitalized, sampled and stored in the FIFO memory 18c.

After the test pattern image is detected, the digital data stored in each of the FIFO memories 18a to 18c are loaded in the CPU1 and RAM3 by a data bus through the I/O port 4. The CPU1 executes programs stored in ROM2 to perform arithmetic processing on each data, and various process including a correction process correcting image forming conditions when forming a full-color image on the intermediate transfer belt 130, a positional shift amount calculation process calculating a positional shift amount in a main scanning direction when forming a pattern image on the intermediate transfer belt 130 and a pattern image correction process.

Thus, the CPU1 and the ROM2 control entire operations of the image forming apparatus 100, and perform a control means of governing processing data detected by the detection sensors 5a to 5c, a correction means, a positional shift amount calculation and a pattern image corrections means as well. In addition, they perform a means of invalidating the pattern image corrections means. The RAM3 is, e.g., NVRAM and stores various parameters as well.

Next, a test pattern image and a correction process based on a detection result thereof are explained.

A case where a pattern image for correcting positional shift is used as the test pattern image is explained.

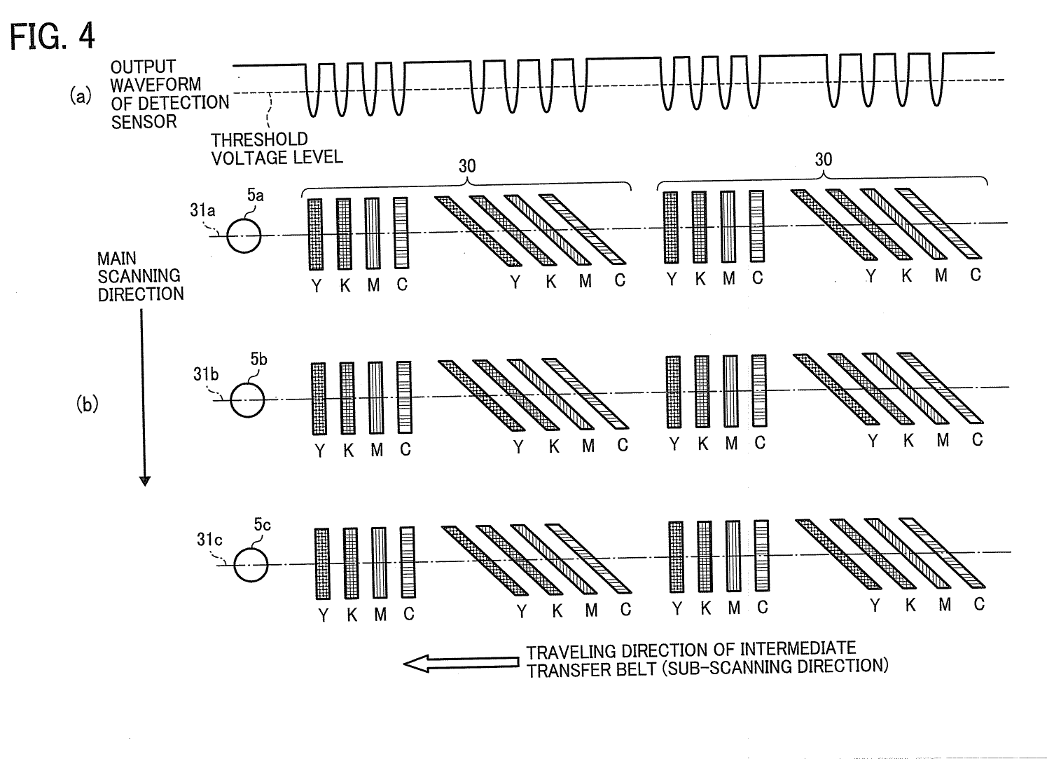

FIG. 4 is a diagram showing a set of marks in a pattern image for correcting positional shift, and a waveform example of a detected result of the set of marks.

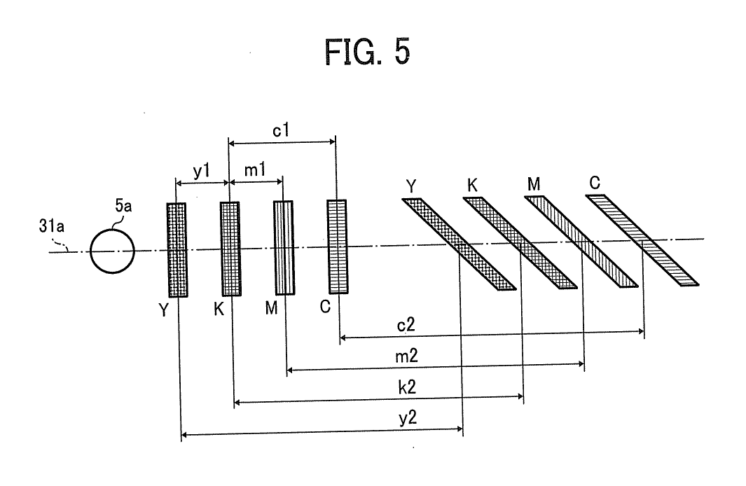

FIG. 5 is a diagram showing a set of marks in the pattern image for correcting positional shift for explaining calculation of a shift amount based on the detected results of the pattern image for correcting positional shift in FIG. 4.

The pattern image for correcting positional shift is a set of marks having a predetermined pattern for alignment for regular-reflected light. As FIG. 4 (b) shows, the pattern image is a pattern image formed of 3 lines of 8 sets (numeral 30 represents one set) of a horizontal (line) pattern and a diagonal (line) pattern, each of which is formed in each Y, K, M and C color order, in a sub-scanning direction for the detection sensors 5a to 5c.

The horizontal pattern includes 4 lines having a predetermined width and a predetermined length, each of which is horizontal relative to a main scanning direction of the photoreceptors 120y to 120c. The diagonal pattern includes 4 diagonal lines having a predetermined inclined angle, e.g., 45° relative to a main scanning direction of the photoreceptors 120y to 120c, a predetermined width and a predetermined length.

Eight sets of the horizontal pattern and the diagonal pattern, each of which is formed in each Y, K, M and C color order, are formed on each of the photoreceptors 120y to 120c, and transferred onto the intermediate transfer belt 130 to form the pattern image for correcting positional shift thereon.

Each of dashed lines 31a to 31c in FIG. 4 (b) represents a trace of each center of the detection sensors 5a to 5c travelling on the intermediate transfer belt 130 in a sub-scanning direction.

FIG. 4 (b) represents an ideal trace of each center of the detection sensors 5a to 5c passing the center of the pattern image for correcting positional shift.

In FIGS. 4 and 5, the horizontal pattern and the diagonal pattern, in each of which Y, K, M and C are lined in this order from the top of a travelling direction of the intermediate transfer belt 130, are formed on the intermediate transfer belt 130. The order of the colors in each of the horizontal patterns and the diagonal patterns may be other orders.

The three mark lines of the pattern image for correcting positional shift formed on the intermediate transfer belt 130 are detected by the detection sensors 5a to 5c each lined in a main scanning direction.

A waveform in FIG. 4 (a) is a detection level variation when a set of the mark 30 in the pattern image for correcting positional shift in FIG. 4(b) is detected by, e.g., the detection sensor 5a. The waveforms detected by the detection sensors 5b and 5c are omitted because of having the same waveforms.

The detection sensors 5a to 5c detect the intermediate transfer belt 130 at areas besides the horizontal patterns and the diagonal patterns. For example, when the intermediate transfer belt 130 is white, the detection level deteriorates at the colored horizontal patterns and the diagonal patterns if the detection level of white is a standard level.

A threshold voltage level (value) shown with a dashed line in FIG. 4 (a) is, even when the detection level lowers due to contamination of the intermediate transfer belt 130, etc., a threshold for detecting a part having lowered the as the horizontal patterns and the diagonal patterns.

The detection sensors 5a to 5c detect positions of 8 sets of the horizontal patterns and the diagonal patterns of the pattern image for correcting positional shift. Based on the detection results, skews of other colors Y, C and M relative to a standard color K, a main scanning registration shift amount, a sub-scanning registration shift amount and a main scanning magnification error are measured.

Based on the measured value, a shift amount between central positions of the detection sensors 5a to 5c and that of the pattern image for correcting positional shift is determined and stored as a positional shift amount referred when forming a following pattern image for correcting positional shift.

Further, correction values of the skew, the main scanning registration shift amount, the sub-scanning registration shift amount and the main scanning magnification error can be determined.

Further, the detection sensors 5a to 5c detect the three mark lines and an average value is calculated. From the calculation result, shift amounts of the skew, the main scanning registration shift amount, the sub-scanning registration shift amount and the main scanning magnification error are determined to precisely determine a shift amount of each color. The shift amount is corrected to form high-quality images having almost no shift of each color.

Calculation of the positional shift amount and the correction amount, and a run command of the correction are executed by an unillustrated known correction amount calculator. Then, the pattern image for correcting positional shift is removed by the cleaner 139 in FIG. 1.

Next, the calculation of various positional (color) shift amounts is specifically explained.

The calculation of various positional (color) shift amounts when detecting the pattern image for correcting positional shift in FIG. 4 is specifically explained, using FIG. 5.

A case where the detection sensor 5a detects the mark line of the pattern image for correcting positional shift is explained, and cases where the other detection sensors 5b and 5c do are the same.

The detection sensor 5a detects the mark line of the pattern image for correcting positional shift at a predetermined constant sampling time interval, and notifies CPU1 in FIG. 3 thereof.

The CPU1, when continuously receiving notifications of the mark line detections from the detection sensor 5a, calculates distances among the horizontal patterns and a distance between each of the horizontal patterns and each of the correspondent diagonal patterns, based on an interval of each of the notifications and the sampling time interval.

Thus, the calculated distances among the horizontal patterns and the distance between each of the horizontal patterns and each of the correspondent diagonal patterns of the same color in the mark line are compared to the calculate various positional shift amounts.

When calculating the sub-scanning registration shift amount (a color shift amount in the sub-scanning direction), the horizontal pattern is used to calculate an interval value (y1, m1 and c1) of each Y, M and C color pattern object to a standard color (K). The interval values y1, m1 and c1 are compared with predetermined ideal interval values y0, m0 and c0, respectively. From y1-y0, m1-m0 and c1-c0, each Y, M and C color positional shift amount relative to the position of the standard color K can be calculated.

When calculating the main scanning registration shift amount (a color shift amount in the main scanning direction), each of interval values k2, y2, m2 and c2 between the horizontal pattern and the diagonal pattern of each K to C color is calculated.

A difference value between the interval value of the standard color (K) and that of the non-standard color is calculated.

The difference value is equivalent to a positional shift amount in the main scanning direction.

This is because the diagonal patterns are inclined at a predetermined angle relative to the main scanning direction and the intervals with the horizontal patterns become longer and shorter than those with the other colors when there is a shift in main scanning direction.

Namely, positional shift amounts in the main scanning direction between black and yellow, black and magenta, and black and cyan are determined by k2-y2, k2-m2, and k2-c2, respectively.

Thus, the registration shift amounts in the sub-scanning and main scanning directions can be obtained.

Further, based on the detection results of the detection sensors 5a to 5c different from each other, the skew and the main scanning magnification error can be deter wined.

The skew component can be obtained by calculating a difference among the sub-scanning registration shift amounts detected by each of the detection sensors 5a to 5c.

The magnification error deviation can be obtained by calculating a difference between the main scanning registration shift amount of the detection sensor 5a and 5b, and that of the detection sensor 5b and 5c.

Based on the above-mentioned various positional shift amounts, a correction process of correcting image forming conditions when forming a full-color image on the intermediate transfer belt 130 is executed.

The above-mentioned correction process is performed by adjusting light emitting timing of the laser beams Y to C to the photoreceptors 120y to 120c such that their positional shifts are almost same.

In addition, this is performed by adjusting inclination of unillustrated reflection mirrors. An unillustrated stepping motor is driven to adjust the inclination.

Further, changing image data can correct the positional shift amount.

Thus, the registration shift amounts in the sub-scanning and main scanning directions can be obtained.

Next, a pattern image correction process in the image forming apparatus 100 is explained.

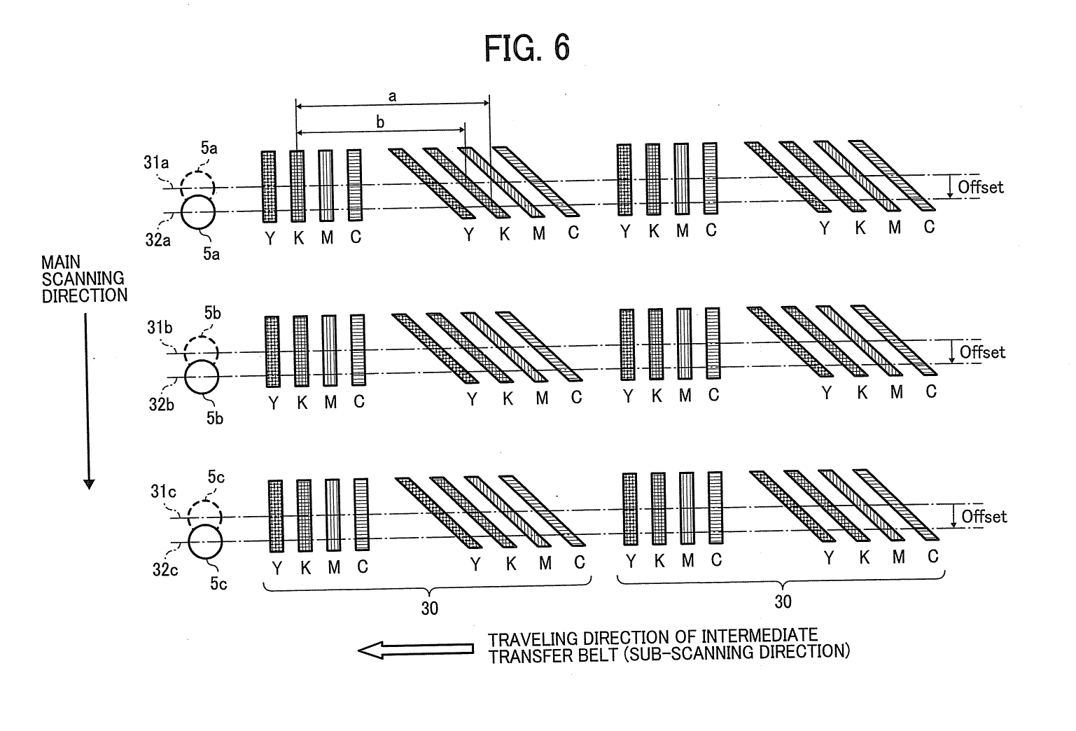

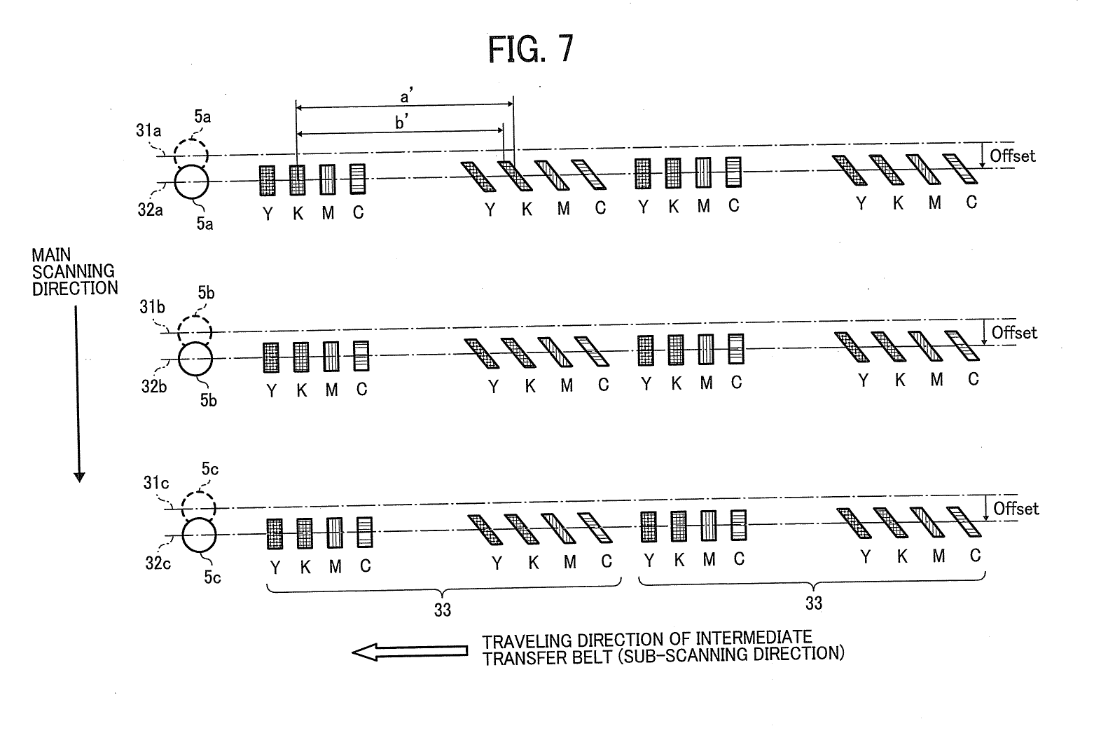

FIG. 6 is a diagram showing a pattern image example for explaining a pattern image correction process of a test pattern image for correcting positional shift, and FIG. 7 is a diagram showing another pattern image example for explaining a pattern image correction process of a test pattern image for correcting positional shift.

The image forming apparatus 100 uses a test pattern image for correcting positional shift 30 to adjust initial images in FIG. 6 and a test pattern image for correcting positional shift 33 to adjust images as time passes in FIG. 7.

The test pattern image for correcting positional shift 30 to adjust initial images in FIG. 6 is a pattern in which a layout of the horizontal patterns of Y to C and that of the diagonal patterns thereof are previously optimized from diameters and intervals of the photoreceptors 120y to 120c and the drive roller such that a detection error of the test pattern image for correcting positional shift is minimum.

First, the test pattern image for correcting positional shift for adjusting initial images 30 is used for correcting positional shift when the image forming apparatus 100 is turned on and returned from energy saving mode.

31a to 31c in FIG. 6 represent an ideal trace of the center of each of the test pattern image for correcting positional shift 30 when scanned relative to the center of each of the detection sensors 5a to 5c when detecting the test pattern image for correcting positional shift in the sub-scanning direction.

However, as 32a to 32c in FIG. 6, the center of each of the detection sensors 5a to 5c occasionally has a positional shift with the center of each of the test pattern image for correcting positional shift.

In addition to the calculations of the positional shift amount and the positional shift correction value from the detection result of the test pattern image for correcting positional shift 30 for adjusting initial images, the detection sensor 5a detects an interval a between the horizontal pattern and the diagonal pattern of a standard color, e.g., K in FIG. 6.

Further, an ideal interval b between the horizontal pattern and the diagonal pattern is previously measured, e.g., before the image forming apparatus 100 is shipped, and the ideal interval b is stored in the memory.

Based on the intervals a and b, the positional shift (offset) of the center of the test pattern image for correcting positional shift relative to the center of the detection sensor 5a is calculated.

The offset is a parameter which equals a-b.

Namely, a difference between the interval a between the diagonal pattern inclined at 45° relative to the traveling direction of the intermediate transfer belt 130 (sub-scanning direction of images) and the horizontal pattern relative thereto, which is detected in the positional shift correction process when the image forming apparatus 100 is turned on and returned from energy saving mode and the ideal interval b previously stored is same as the positional shift of the center of the test pattern image for correcting positional shift relative to the center of the detection sensor 5a. The offset value is stored in, e.g., RAM3.

The offset value is assumed, e.g., to be shifted from the ideal central position 31a in the main scanning direction when positive, and shifted therefrom in an opposite direction of the main scanning direction when negative.

A test pattern image for correcting positional shift for adjusting images as time passes 33 in FIG. 7 is used in a positional shift correction process when adjusting images as time passes except when the image forming apparatus 100 is turned on and returned from energy saving mode.

The test pattern image for correcting positional shift for adjusting images as time passes 33 just has a smaller main scanning width than the test pattern image for correcting positional shift for adjusting initial images 30 in FIG. 6. For example, a parameter of a pattern width of the test pattern image for correcting positional shift for adjusting images as time passes is previously stored in RAM3, CPU1 forms the test pattern image for correcting positional shift for adjusting images as time passes 33, based on the pattern width for adjusting images as time passes stored in RAM3. The pattern width for adjusting images as time passes is applied to each of patterns detected by the detection sensors 5a to 5c.

Further, when the test pattern image for correcting positional shift for adjusting images as time passes 33 is formed on the intermediate transfer belt 130, CPU1 shifts the pattern by the offset value stored in RAM3. The shift is applied to each of the patterns detected by the detection sensors 5a to 5c.

Thus, when images as time passes are adjusted, the test pattern image for correcting positional shift for adjusting images as time passes 33 having a smaller pattern width than the test pattern image for correcting positional shift for adjusting initial images is formed, and toner consumption is largely reduced.

When the test pattern image for correcting positional shift for adjusting images as time passes 33 is shifted by the offset value, the detection sensors 5a to 5c can reliably detect each of the patterns having a smaller main scanning width.

Further, since the test pattern image for correcting positional shift for adjusting images as time passes 33 just has a smaller main scanning width than the test pattern image for correcting positional shift for adjusting initial images, image adjustment precision of positional shift does not deteriorate and downtime does not increase because the precision does not change even with a single adjustment.

Next, even when the test pattern image for correcting positional shift for adjusting images as time passes is used, as when the pattern image for correcting positional shift for adjusting initial images is used, a value based on an interval a′ between the horizontal pattern and the diagonal pattern and an interval b′ (=interval b) between the ideal horizontal pattern and the diagonal pattern at the center of the pattern renews a positional shift amount (offset) at the center if the pattern relative to the center of the detection sensors 5a to 5c of RAM3 as shown in FIG. 7.

Namely, when offset=offset+(a′−b′), the test pattern image for correcting positional shift for adjusting images as time passes 33 can be used when adjusting the following positional shift, and the pattern can precisely come to each of the detection sensors 5a to 5c.

Thus, once the offset value is detected at an initial adjustment timing, the test pattern image for correcting positional shift for adjusting images as time passes 33 having a small main scanning width can be used for adjustments since then.

The initial adjustment timing is a timing when the image forming apparatus is turned on and returned from energy saving mode. An elapsed time or an environmental variation from the last positional shift adjustment is large, and it is possible that a pattern writing position largely changes. In addition, when the image forming apparatus 100 is moved, the detection positions of the detection sensors 5a to 5c are possibly shifted.

The pattern image for correcting positional shift for adjusting initial images may be used only for the first positional adjustment after the image forming apparatus 100 is assembled.

Next, other pattern image correction processes in the image forming apparatus 100 are explained.

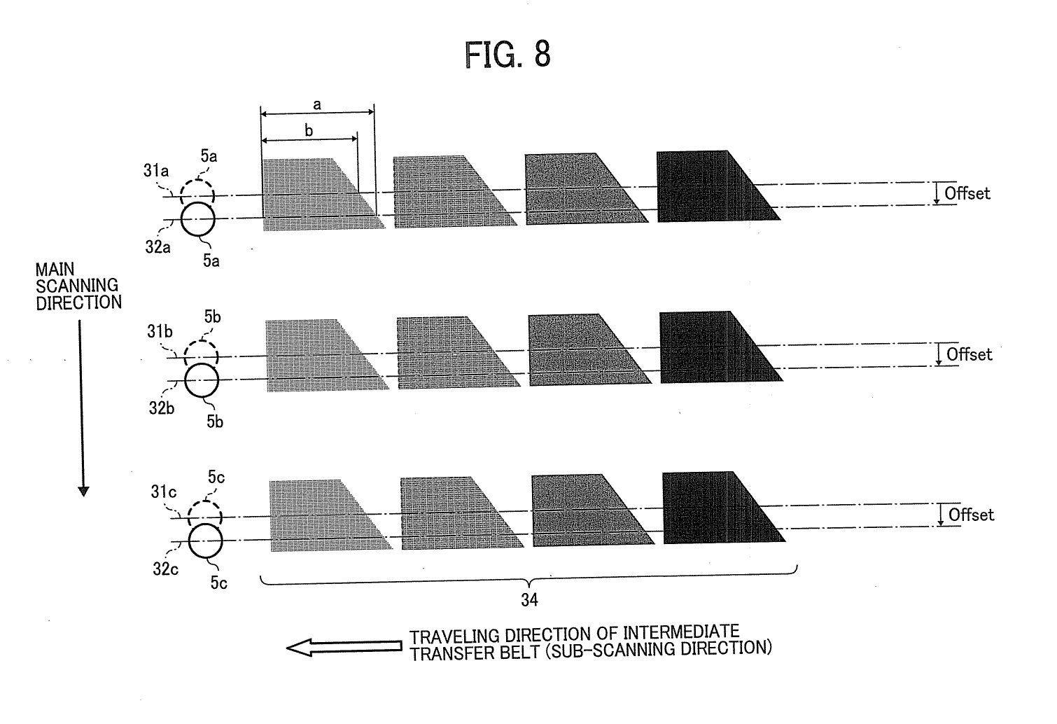

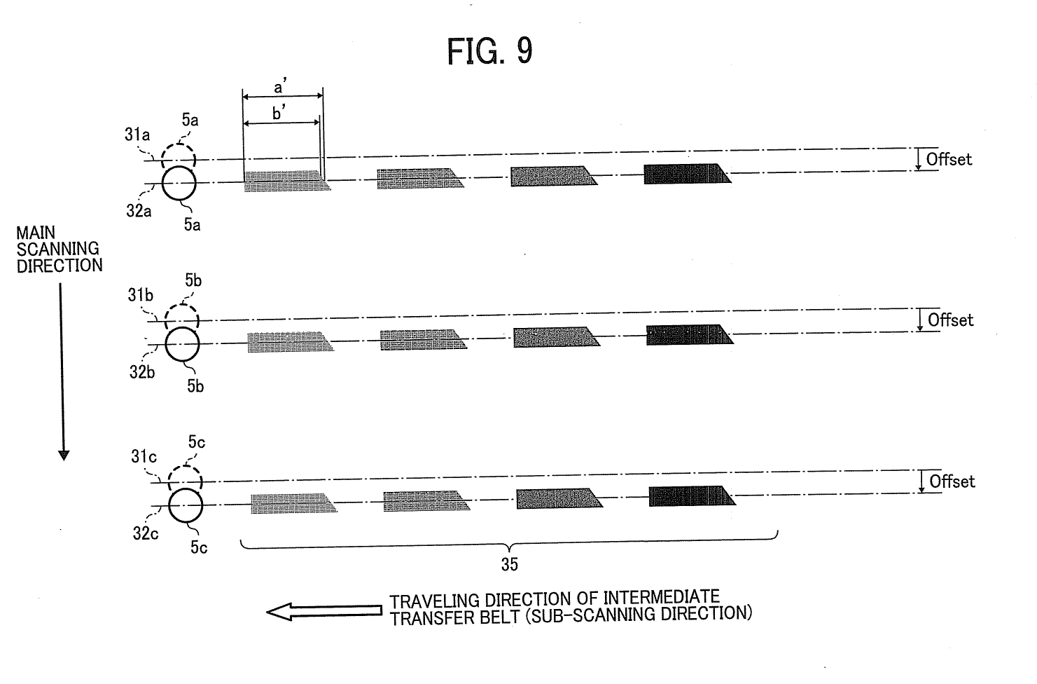

FIG. 8 is a diagram showing a pattern image example for explaining a pattern image correction process of a test pattern image for correcting image density, and FIG. 9 is a diagram showing another pattern image example for explaining a pattern image correction process of a test pattern image for correcting image density.

The image forming apparatus 100 performs the above-mentioned same pattern image correction process even in image density correction. Two test patterns, i.e., a test pattern image for correcting image density for adjusting initial images 34 in FIG. 8 and a test pattern image for correcting image density for adjusting images as time passes 35 in FIG. 9 are used.

First, the test pattern image for correcting image density for adjusting initial images 34 is used for correcting image density when the image forming apparatus 100 is turned on and returned from energy saving mode.

FIG. 8 shows plural patterns having different image densities of the test pattern image for correcting image density for adjusting initial images 34. 31a to 31c represent an ideal trace of the center of each of the test pattern image for correcting image density when scanned relative to the center of each of the detection sensors 5a to 5c when detecting the test pattern image for correcting image density in the sub-scanning direction.

However, as 32a to 32c in FIG. 8, the center of each of the detection sensors 5a to 5c occasionally has a positional shift with the center of each of the test pattern image for correcting image density.

In addition to the calculations of the image density correction from the detection result of the test pattern image for correcting image density 34 for adjusting initial images, the above-mentioned same pattern image correction process is performed.

Known image density adjustment process is simply explained.

Toner concentration is adjusted by forming plural patterns having different image density as shown in FIG. 8 and detecting toner adherence amount using a diffusion light sensor for the detection sensors 5a to 5c varying output values depending on image density.

The patterns having different image density are produced by varying a bias quantity when a toner is transferred onto the intermediate transfer belt 130 from the photoreceptor 120y to 120c.

Based on the detection result of the test pattern image for correcting image density, a relation between a bias when a toner image is transferred onto the intermediate transfer belt 130 from the photoreceptor 120y to 120c and a toner adherence amount on the intermediate transfer belt 130 can be drawn.

Based on the drawn result, a proper bias and a proper LD light amount in accordance with image forming conditions are set to produce images having proper image density.

Next, as for a pattern image correction process, one side of the test pattern for adjusting image density is horizontal and the other side thereof is inclined at an angle of 45° relative to a traveling direction (sub-scanning direction of images) of the intermediate transfer belt 130. The detection sensor 5a detects an interval a between both edges of the pattern, an ideal interval b is previously determined, e.g., before the image forming apparatus 100 is shipped, and the interval b is stored in a memory. The interval b has a width detectable when the center of the pattern is scanned.

Based on the intervals a and b, the positional shift (offset) of the center of the test pattern image for correcting image density relative to the center of the detection sensor 5a is calculated and stored in RAM3.

The offset value is assumed, e.g., to be shifted from the ideal central position 31a in the main scanning direction when positive, and shifted therefrom in an opposite direction of the main scanning direction when negative.

A test pattern image for correcting image density for adjusting images as time passes 35 in FIG. 9 is used in an image density correction process when adjusting images as time passes except when the image forming apparatus 100 is turned on and returned from energy saving mode.

The test pattern image for correcting image density for adjusting images as time passes 35 just has a smaller main scanning width than the test pattern image for correcting image density for adjusting initial images 34 in FIG. 8. For example, a parameter of a pattern width of the test pattern image for correcting image density for adjusting images as time passes is previously stored in RAM3, CPU1 forms the test pattern image for correcting image density for adjusting images as time passes 33, based on the pattern width for adjusting images as time passes stored in RAM3. The pattern width for adjusting images as time passes is applied to each of patterns detected by the detection sensors 5a to 5c.

Further, when the test pattern image for correcting image density for adjusting images as time passes 35 is formed on the intermediate transfer belt 130, CPU1 shifts the pattern by the offset value stored in RAM3. The shift is applied to each of the patterns detected by the detection sensors 5a to 5c.

Thus, when images as time passes are adjusted, the test pattern image for correcting image density for adjusting images as time passes having a smaller pattern width than the test pattern image for correcting image density for adjusting initial images is formed, and toner consumption is largely reduced.

When the test pattern image for correcting image density for adjusting images as time passes 35 is shifted by the offset value, the detection sensors 5a to 5c can reliably detect each of the patterns having a smaller main scanning width.

Further, since the test pattern image for correcting image density for adjusting images as time passes 35 just has a smaller main scanning width than the test pattern image for correcting image density for adjusting initial images, image adjustment precision of image density does not deteriorate and downtime does not increase because the precision does not change even with a single adjustment.

Next, even when the test pattern image for correcting image density for adjusting images as time passes 35 is used, as when the pattern image for correcting image density for adjusting initial images is used, a value based on an interval a′ between the horizontal pattern and the diagonal pattern and an interval b′ (=interval b) between the ideal horizontal pattern and the diagonal pattern at the center of the pattern renews a positional shift amount (offset) at the center if the pattern relative to the center of the detection sensors 5a to 5c of RAM3 as shown in FIG. 9.

Namely, when offset=offset+(a′−b′), the test pattern image for correcting image density for adjusting images as time passes can be used when adjusting the following image density, and the pattern can precisely come to each of the detection sensors 5a to 5c.

Thus, once the offset value is detected at an initial adjustment timing, the test pattern image for correcting image density for adjusting images as time passes 35 having a small main scanning width can be used for adjustments since then.

The initial adjustment timing is a timing when the image forming apparatus is turned on and returned from energy saving mode. An elapsed time or an environmental variation from the last image density adjustment is large, and it is possible that a pattern writing position largely changes.

The pattern image for correcting image density for adjusting initial images 34 may be used only for the first image density adjustment after the image forming apparatus 100 is assembled.

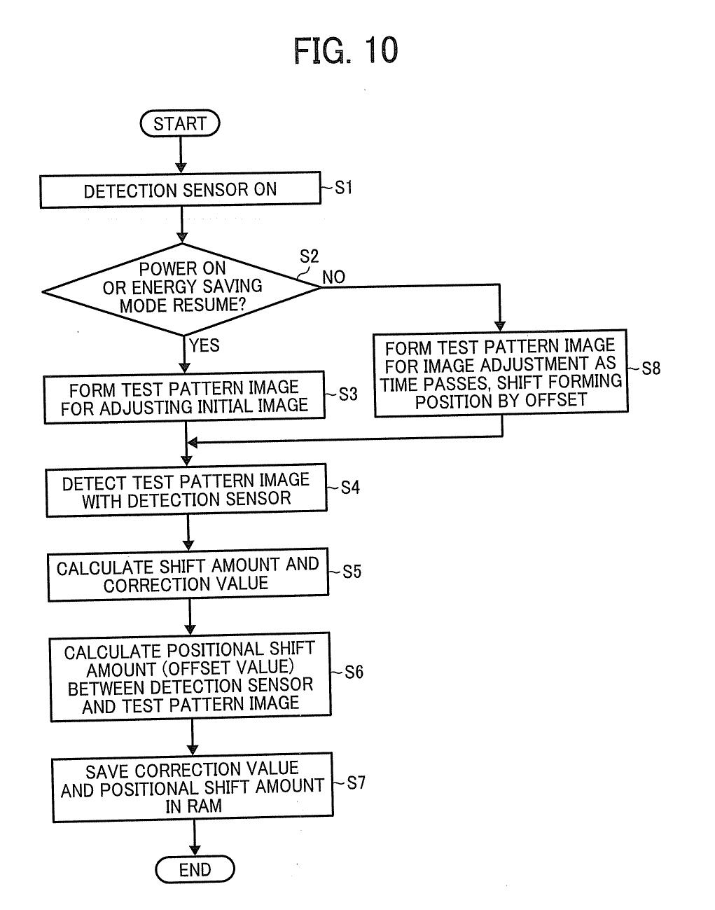

FIG. 10 is a flowchart showing the above-mentioned pattern image correction process.

When CPU1 in FIG. 3 performs image adjustment process of positional shift and image density, in STEP (S) 1, the detection sensor is on such that the test pattern image for correcting positional shift or the test pattern image for correcting image density can be detected, and which is followed by STEP 2.

In STEP 2, whether the image forming apparatus is turned on or returned from energy saving mode is judged. When the image forming apparatus is turned on or returned from energy saving mode (Y), in STEP 3, a test pattern image for adjusting initial images (a test pattern image for correcting positional shift for adjusting initial images or a test pattern image for correcting image density for adjusting initial images) is formed on the intermediate transfer belt, and which is followed by STEP 4.

In STEP 2, when the image forming apparatus is neither turned on nor returned from energy saving mode (N), in STEP 8, a test pattern image for adjusting images as time passes (a test pattern image for correcting positional shift for adjusting images as time passes or a test pattern image for correcting image density for adjusting images as time passes) is formed on the intermediate transfer belt and a position where the test pattern image for adjusting images as time passes is shifted by an offset, and which is followed by STEP 4.

In STEP 4, the detection sensor detects the test pattern image, in STEP 5, a positional shift amount or an image density shift amount and its correction value (amount) are calculated, and which is followed by STEP 6.

In STEP 6, positional shift (offset) amounts of the detection sensor and the test pattern image are calculated, and which is followed by STEP 7.

The above-mentioned positional shift amounts include a positional shift amount of the center of the test pattern image for correcting positional shift relative to the center of the detection sensor, and a positional shift amount of the center of the test pattern image for correcting image density relative to the center of the detection sensor.

In STEP 7, the above-mentioned correction value (amount) and the positional shift amounts are stored in RAM, and this process is finished.

Next, when each of the detection sensors 5a to 5c are located at different positions in the main scanning direction of the intermediate transfer belt 130, an average value of positional shift amounts obtained by each of the detection sensors 5a to 5c may be a positional shift amount when a position where the test pattern image is shifted.

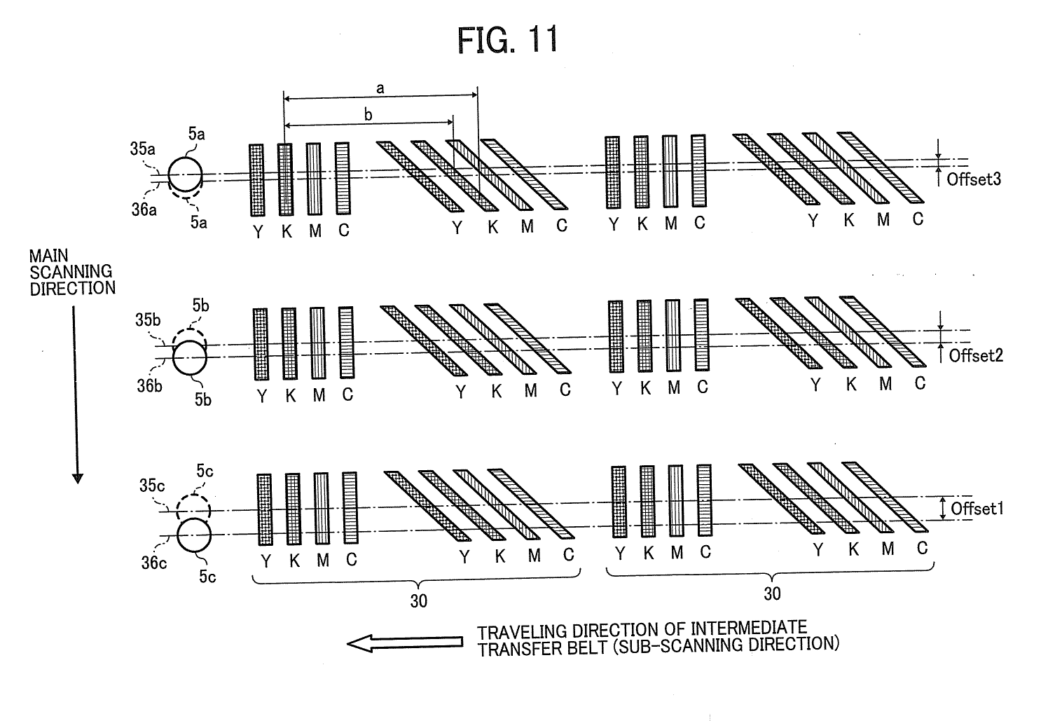

FIG. 11 is a diagram showing a test pattern image for correcting positional shift example formed when each of the detection sensors 5a to 5c are located at different positions in the main scanning direction of the intermediate transfer belt 130.

A dashed line 35a to 35c in FIG. 11 represent ideal trace of the center of each of the detection sensors 5a to 5c travels in the sub-scanning direction on the intermediate transfer belt 130.

36a to 36c in FIG. 11 represent an ideal trace of the center of each of the test pattern image for correcting positional shift 30 when scanned relative to the center of each of the detection sensors 5a to 5c when detecting the test pattern image for correcting positional shift in the sub-scanning direction.

For example, as FIG. 11 shows, when the detection sensors 5a to 5c is located at different positions in the main scanning direction of the intermediate transfer belt 130 such that an interval between the detection sensors 5a and 5b and that between the detection sensors 5b and 5c are different from each other, CPU1 calculates an positional shift amount of each of the detection sensors 5a to 5c in the main scanning direction when the test pattern image for correcting positional shift on the intermediate transfer belt 130.

Namely, when an interval between the dashed lines 35a and 36a of the detection sensor 5a is offset 3, an interval between the dashed lines 35b and 36b of the detection sensor 5b is offset 2, and an interval between the dashed lines 35c and 36c of the detection sensor 5c is offset 1, offset equals (offset 1+offset 2+offset 3)/3.

An average of the calculated positional shift amounts is stored in RAM3 in FIG. 3 as a positional shift amount equivalent to a shift amount when the test pattern image for correcting positional shift in adjusting images as time passes is formed on the intermediate transfer belt 130.

As mentioned above, the average of the calculated positional shift amounts of the detection sensors 5a to 5c may be a positional shift amount even when a position where the test pattern image for correcting image density is formed is shifted.

Thus, the pattern can be formed at the most suitable position where all the detections sensors can read the pattern. Therefore, even when the plural detection sensors 5a to 5c detect positional shift amounts (offset) different from each other, the pattern image has the most suitable shift amount.

Even when the detection sensors 5a to 5c arc located at the same intervals, as mentioned above, the average of the calculated positional shift amounts of the detection sensors 5a to 5c may be a positional shift amount when a position where the test pattern image for correcting image density is formed is shifted.

Next, a pattern width of the pattern image for adjusting images as time passes is explained.

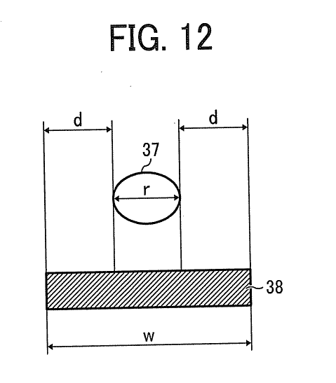

FIG. 12 is a schematic view for explaining a pattern width of a test pattern image for adjusting images as time passes.

Pattern widths of the test pattern image for correcting positional shift for adjusting images as time passes and that for correcting image density therefor in the main scanning direction are smaller than those for adjusting initial images to'reduce toner consumption.

As FIG. 12 shows, from a diameter r of a detection spot 37 of each of the detection sensors 5a to 5c (detection spot diameter of light emitted to detect the pattern image) and a positional shift amount d assumed when the positional shift is adjusted (a preset positional shift), a (main scanning) width smaller than the initial value w (=r+(d×2)) is previously calculated and stored in RAM3, and CPU1 refers thereto when performing the pattern image correction process. FIG. 12 illustrates a width w of a horizontal pattern 38 for correcting positional shift, and widths of the diagonal pattern and the pattern for correcting image density are similarly set.

The preset positional shift amount d is a positional shift amount assumed at a preset timing of executing adjustment of positional shift of images, i.e., in the regular interval, e.g., when the temperature has changed by 5° C. since the positional shift of an image was adjusted last, when 200 pieces of an image are produced, and when 10 minutes have passed.

The test pattern width for adjusting images as time passes satisfying the preset positional shift amount d can be minimal and an effect of reducing toner consumption can be maximized.

Additional modifications and variations of the present invention are possible in light of the above teachings. It is therefore to be understood that within the scope of the appended claims the invention may be practiced other than as specifically described herein.

What is claimed is:

1. An image forming apparatus, comprising:
an image forming unit configured to overlappingly transfer a different color toner image formed on each of plural image bearers onto an intermediate transfer member to form a full-color image thereon;
a pattern image forming unit configured to form a pattern image on the intermediate transfer member for correcting image forming conditions when the image forming unit forms the full-color image on the intermediate transfer member;
a pattern image detecting unit configured to detect the pattern image;
a correcting unit configured to correct the image forming conditions when the image forming unit forms the full-color image on the intermediate transfer member, based on a detected result of the pattern image detecting unit;
a positional shift amount calculating unit configured to calculate a positional shift amount when the pattern image forming unit forms a pattern image on the intermediate transfer member, based on a detected result of the pattern image detecting unit;
a positional shift amount storage unit configured to store the positional shift amount calculated by the positional shift amount calculating unit; and
a pattern image correcting unit configured to correct a position of the pattern image in a main scanning direction and to reduce a width of the pattern image from an initial preset width in the main scanning direction based on the positional shift amount stored by the positional shift amount storage unit when the pattern image forming unit forms a pattern image on the intermediate transfer member.

2. The image forming apparatus of claim 1, wherein the pattern image is a pattern image for correcting a positional shift to correct image forming conditions such that the positions of the color toner images transferred onto the intermediate transfer member from the plural image bearers coincide when the full-color image is formed thereon by the image forming unit.

3. The image forming apparatus of claim 1, wherein the pattern image is a pattern image for correcting image density to correct image forming conditions such that the image densities of each of the color toner images transferred on the plural image bearers are identical when the full-color image is formed thereon by the image forming unit.

4. The image forming apparatus of claim 1, further comprising a unit configured to disable the pattern image correcting unit when forming the pattern image with the pattern image forming unit under preset conditions.

5. The image forming apparatus of claim 1, further comprising a plurality of the pattern image detecting units located at different positions on the intermediate transfer member in the main scanning direction, wherein the positional shift amount calculating unit calculates positional shift amounts of pattern images formed on the intermediate transfer member in the main scanning direction detected by each of the pattern image detecting units, and uses an average of the positional shift amounts as a positional shift amount of the pattern image when formed on the intermediate transfer member in the main scanning direction.

6. The image forming apparatus of claim 1, wherein the pattern image correcting unit sets a pattern width (w) smaller than an initial preset value based on the following formula:
w=r+(d×2)
wherein r represents a spot diameter of light emitted from the pattern image detecting unit to detect the pattern image and d represents a preset positional shift amount.

7. An image forming method, comprising:
overlappingly transferring a different color toner image formed on each of plural image bearers onto an intermediate transfer member to form a full-color image thereon;
forming a pattern image on the intermediate transfer member for correcting image forming conditions when the image forming unit forms the full-color image on the intermediate transfer member;
detecting the pattern image;
correcting the image forming conditions when the image forming unit forms the full-color image on the intermediate transfer member, based on a detected result of the pattern image detecting unit;
calculating a positional shift amount when the pattern image forming unit forms a pattern image on the intermediate transfer member, based on a detected result of the pattern image detecting unit;
storing the positional shift amount calculated by the positional shift amount calculating unit in a positional shift amount storage unit; and
correcting a position of the pattern image in a main scanning direction and reducing a width of the pattern image from an initial preset width in the main scanning direction based on the positional shift amount stored by the positional shift amount storage unit when the pattern image forming unit forms a pattern image on the intermediate transfer member.

8. The image forming method of claim 7, wherein the pattern image is a pattern image for correcting a positional shift to correct image forming conditions such that the positions of the color toner images transferred onto the intermediate transfer member from the plural image bearers coincide when the full-color image is formed thereon by the image forming unit.

9. The image forming method of claim 7, wherein the pattern image is a pattern image for correcting image density to correct image forming conditions such that the image densities of each of the color toner images transferred on the plural image bearers are identical when the full-color image is formed thereon by the image forming unit.

10. The image forming method of claim 7, further comprising:
disabling the pattern image correcting unit when forming the pattern image under preset conditions.

11. The image forming method of claim 7, further comprising:
calculating positional shift amounts of pattern images formed on the intermediate transfer member in the main scanning direction detected by each of plural pattern image detecting units located at different positions on the intermediate transfer member in the main scanning direction,
wherein an average of the positional shift amounts is a positional shift amount of the pattern image when formed on the intermediate transfer member in the main scanning direction.

12. The image forming method of claim 7, further comprising setting a pattern image width (w) smaller than an initial preset value based on the following formula:
w=r+(d×2)
wherein r represents a spot diameter of light emitted from the pattern image detecting unit to detect the pattern image and d represents a preset positional shift amount.

13. An image forming apparatus, comprising:
an image forming means for overlappingly transferring a different color toner image formed on each of plural image bearers onto an intermediate transfer member to form a full-color image thereon;
a pattern image forming means for forming a pattern image on the intermediate transfer member for correcting image forming conditions when the image forming means forms the full-color image on the intermediate transfer member;
a pattern image detecting means for detecting the pattern image;
a correcting means for correcting the image forming conditions when the image forming means forms the full-color image on the intermediate transfer member, based on a detected result of the pattern image detecting means;
a positional shift amount calculating means for calculating a positional shift amount when the pattern image forming means forms a pattern image on the intermediate transfer member, based on a detected result of the pattern image detecting means;
a positional shift amount storing means for storing the positional shift amount calculated by the positional shift amount calculating means; and
a pattern image correcting means for correcting a position of the pattern image in a main scanning direction and reducing a width of the pattern image from an initial preset width in the main scanning direction based on the positional shift amount stored by the positional shift amount storing means when the pattern image forming means forms a pattern image on the intermediate transfer member.

14. The image forming apparatus of claim 13, wherein the pattern image is a pattern image for correcting a positional shift to correct image forming conditions such that the positions of the color toner images transferred onto the intermediate transfer member from the plural image bearers coincide when the full-color image is formed thereon by the image forming means.

15. The image forming apparatus of claim 13, wherein the pattern image is a pattern image for correcting image density to correct image forming conditions such that the image densities of each of the color toner images transferred on the plural image bearers are identical when the full-color image is formed thereon by the image forming means.

16. The image forming apparatus of claim 13, further comprising a means for disabling the pattern image correcting means when forming the pattern image with the pattern image forming means under preset conditions.

17. The image forming apparatus of claim 13, further comprising a plurality of the pattern image detecting means located at different positions on the intermediate transfer member in the main scanning direction, wherein the positional shift amount calculating means calculates positional shift amounts of pattern images formed on the intermediate transfer member in the main scanning direction detected by each of the pattern image detecting means, and uses an average of the positional shift amounts as a positional shift amount of the pattern image when formed on the intermediate transfer member in the main scanning direction.

18. The image forming apparatus of claim 13, wherein the pattern image correcting means sets a pattern image width (w) smaller than an initial preset value based on the following formula:
w=r+(d×2)
wherein r represents a spot diameter of light emitted from the pattern image detecting means to detect the pattern image and d represents a preset positional shift amount.
